(19) United States
(12) Patent Application Publication
(10) Pub. No.: US 2026/0081553 A1
(43) Pub. Date: Mar. 19, 2026

(54) DRIVE DEVICE

(71) Applicant: TOYOTA JIDOSHA KABUSHIKI KAISHA, Toyota-shi (JP)

(72) Inventor: Shohei OI, Okazaki-shi (JP)

(73) Assignee: TOYOTA JIDOSHA KABUSHIKI KAISHA, Toyota-shi (JP)

(21) Appl. No.: 19/184,400

(22) Filed: Apr. 21, 2025

(30) Foreign Application Priority Data
Sep. 19, 2024 (JP) 2024-161977

(51) Int. Cl. H02P 29/68; H02P 27/06; H02P 29/62

(52) U.S. Cl. CPC H02P 29/68; H02P 27/06; H02P 29/62

(57) ABSTRACT

When electrified vehicle executes the warm-up control for raising the temperature of the motor and/or the first and second inverters, the positive-side switch is turned on, and the duty command based on the feedforward term and the feedback term is set so that the phase current of each phase of the motor circulates through the inverter of one of the first and second inverters, the positive-side line and the negative-side line, and the other of the first and second inverters to control the first and second inverters. When the temperature of the positive-side switch is higher than the first temperature in the warm-up control, the feedforward term is made smaller than in the case where the temperature of the positive-side switch is equal to or lower than the first temperature.

### CROSS-REFERENCE TO RELATED APPLICATION

This application claims priority to Japanese Patent Application No. 2024-161977 filed on September 19, 2024. The disclosure of the above-identified application, including the specification, drawings, and claims, is incorporated by reference herein in its entirety.

### BACKGROUND

### Technical Field

The present disclosure relates to a drive device.

### Description of Related Art

Conventionally, a control device for a motor including a phase changing mechanism has been proposed (e.g., see Japanese Unexamined Patent Application Publication No. 2009-44805 (JP 2009-44805 A)). The phase changing mechanism is made up of first and second rotors, each in which magnet pieces are disposed, and first and second working chambers in which the first and second rotors are rotated relative to each other to change a phase indicating a relative rotation angle therebetween when a working fluid is supplied. When a temperature of the working fluid is lower than a predetermined value, the control device applies electric power to a stator coil of the motor to warm the working fluid.

### SUMMARY

Now, a drive device including a power storage device, a motor having a three-phase open winding, a first inverter, a second inverter, and a positive-side switch provided at a portion of a positive-side line between the first and second inverters has also been devised. The first inverter is connected to the positive-side line and a negative-side line to which the power storage device is connected, and is also connected to one end side of the three-phase open winding. The second inverter is connected to the positive-side line and the negative-side line, and is also connected to the other end side of the three-phase open winding. In this drive device, when warm-up control for warming the motor and/or the first and second inverters is executed, in a state in which the positive-side switch is turned on, the first and second inverters are controlled such that phase current of each phase of the motor circulates through one inverter of the first and second inverters, a portion of the positive-side line and a portion of the negative-side line between the first and second inverters, and the other inverter of the first and second inverters. There is demand for suppressing temperature of the positive-side switch from rising excessively during this warm-up control.

A primary object of the drive device according to the present disclosure is to suppress the temperature of the positive-side switch from rising excessively during warm-up control.

In order to achieve the above primary object, the drive device according to the present disclosure adopts the following measures.

A key aspect of the present disclosure is a drive device including a power storage device, a motor with a three-phase open winding, a first inverter that is connected to a positive-side line and a negative-side line to which the power storage device is connected, and that is also connected to one end side of the three-phase open winding, a second inverter that is connected to the positive-side line and the negative-side line, and that is also connected to another end side of the three-phase open winding, a positive-side switch that is provided between the first and second inverters of the positive-side line, and a control device that, when executing warm-up control for warming at least one of the motor and the first and second inverters, in a state in which the positive-side switch is on, controls the first and second inverters by setting first and second duty commands such that a phase current of each phase of the motor circulates via one inverter of the first and second inverters, a portion of the positive-side line and a portion of the negative-side line between the first and second inverters, and the other inverter of the first and second inverters, in which, when a temperature of the positive-side switch is higher than a first temperature during the warm-up control, the control device reduces the first and second duty commands as compared with a case in which the temperature of the positive-side switch is no higher than the first temperature.

In the drive device according to the present disclosure, the control device turns the positive-side switch to the on state when executing warm-up control for warming the motor and/or the first and second inverters. The control device then controls the first and second inverters by setting the first and second duty commands such that the phase current of each phase of the motor circulates via one inverter of the first and second inverters, the portion of the positive-side line and the portion of the negative-side line between the first and second inverters, and the other inverter of the first and second inverters. When the temperature of the positive-side switch is higher than the first temperature during this warm-up control, the first and second duty commands are set so as to be smaller than when the temperature of the positive-side switch is no higher than the first temperature. Accordingly, when the temperature of the positive-side switch is higher than the first temperature during the warm-up control, an absolute value of the current of the portion of the positive-side line between the first and second inverters can be reduced, and the temperature of the positive-side switch can be suppressed from rising excessively.

In the drive device according to the present disclosure, during the warm-up control, the control device may add a feedback term to a feedforward term and set one of the first and second duty commands, and also subtract the feedback term from the feedforward term and set the other of the first and second duty commands, and when the temperature of the positive-side switch is higher than the first temperature, set the feedforward term to be smaller than when the temperature of the positive-side switch is no higher than the first temperature.

The drive device according to the present disclosure may further include a negative-side switch that is provided between the first and second inverters of the negative-side line, in which when a temperature of the negative-side switch is higher than a second temperature during the warm-up control, the control device may set the first and second duty commands to be greater as compared with a case in which the temperature of the negative-side switch is no higher than the second temperature. Accordingly, when the temperature of the negative-side switch is higher than the second temperature during warm-up control, the absolute value of the current on the negative-side line between the first and second inverters is reduced, and the temperature of the negative-side switch can be suppressed from rising excessively.

In the drive device according to the present disclosure, during the warm-up control, the control device may add a feedback term to a feedforward term and set one of the first and second duty commands, and also subtract the feedback term from the feedforward term and set the other of the first and second duty commands, when the temperature of the positive-side switch is higher than the first temperature, set the feedforward term to be smaller than when the temperature of the positive-side switch is no higher than the first temperature, and when the temperature of the negative-side switch is higher than the second temperature, set the feedforward term to be greater than when the temperature of the positive-side switch is no higher than the second temperature.

In the drive device according to the present disclosure, the control device may add, to a basic value of the feedforward term, a first correction value that becomes smaller the higher the temperature of the positive-side switch is, and a second correction value that becomes greater the higher the temperature of the negative-side switch is, and calculate the feedforward term.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a battery electric vehicle according to an embodiment of the present disclosure;

FIG. 2 is an explanatory diagram illustrating an example of functional blocks for the U-phase of the first and second inverters in the warm-up control;

FIG. 3 is an explanatory diagram illustrating an exemplary first correction-amount map; and

FIG. 4 is an explanatory diagram illustrating an example of a second correction amount map.

### DETAILED DESCRIPTION OF EMBODIMENTS

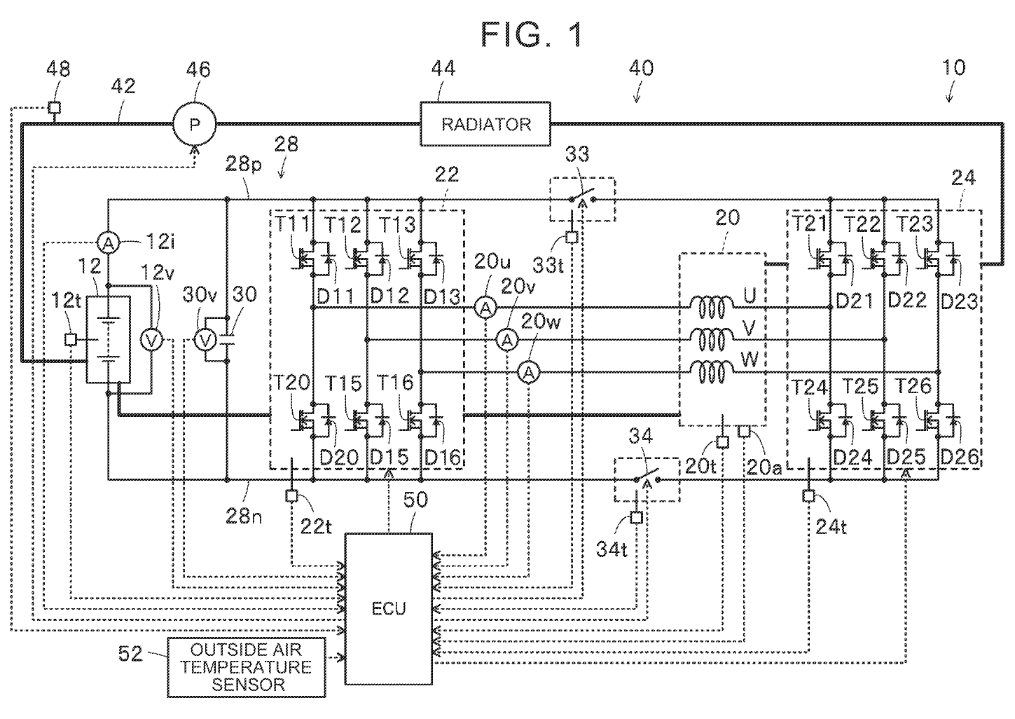

Embodiments for carrying out the present disclosure will be described with reference to the drawings. FIG. 1 is a schematic configuration diagram of a battery electric vehicle 10 according to an embodiment of the present disclosure. As illustrated, battery electric vehicle 10 of the embodiment includes a battery 12 as a power storage device, a motor 20, first and second inverters 22 and 24, a capacitor 30, a positive-side switch 33 and a negative-side switch 34, a cooling device 40, and an electronic control unit (hereinafter referred to as "ECU") 50 as a control device.

The battery 12 is configured as, for example, a lithium-ion secondary battery or a nickel-hydrogen secondary battery, and is connected to the power line 28 (the positive-side line 28p and the negative-side line 28n). The motor 20 is configured as a three-phase AC motor, and includes a rotor in which a permanent magnet is embedded in a rotor core, and a stator in which a three-phase (U-phase, V-phase, and W-phase) coil (three-phase open winding) is wound around the stator core. The rotor is connected to a drive shaft connected to the drive wheels via a differential gear.

The first and second inverters 22 each include six transistors T11 to T16, T21 to T26 as a plurality of switching elements, and six diodes D11 to D16, D21 to D26 connected in parallel to each other from six transistors T11 to T16, T21 to T26. As T26 from the transistors T11 to T16, T21, for example, MOSFET or IGBT is used. The transistors T11 to T16, T21 to T26 are arranged in pairs so as to be on the source-side and the sink-side with respect to the positive-side line 28p and the negative-side line 28n, respectively. Each of the connecting points of the two transistors that are the pair of the transistors T11 to T16 is connected to each of the one end side of the three-phase coils of the motor 20. Each of the connecting points of the two transistors that are the pair of the transistors T21 to T26 is connected to each of the other end side of the three-phase coils of the motor 20. Hereinafter, T23 from the transistor T11 to T13, T21 may be referred to as an "upper arm", and T25 from the transistor T14 to T16, T24 may be referred to as a "lower arm".

The capacitor 30 is connected to the vicinity of the first inverter 22 in the power line 28. In the embodiment, the battery 12, the capacitor 30, the first inverter 22, and the second inverter 24 are connected to the power line 28 in this order from the left side of FIG. 1. The positive-side switch 33 and the negative-side switch 34 are provided between the first and second inverters 22 and 24 of the positive-side line 28p and the negative-side line 28n, respectively. The positive-side switch 33 and the negative-side switch 34 may be semiconductor-type switches, relays, or the like.

The cooling device 40 includes a circulation flow path 42, a radiator 44, and an electric pump 46. The circulation flow path 42 is configured as a flow path for circulating the coolant to the second inverter 24, the motor 20, the first inverter 22, the battery 12, and the radiator 44 in this order. The electric pump 46 pumps (circulates) the coolant in the circulation flow path 42. The circulation flow path 42 may be configured to circulate the coolant to the motor 20 and the first and second inverters 22 and 24 in any order.

ECU 50 includes a microcomputer having a CPU, ROM, RAM, a flash memory, an input/output port, and a communication port, various driving circuitry, and various logic IC. ECU 50 receives signals from various sensors. For example, the voltage Vb of the battery 12 from the voltage sensor 12v, the current Ib of the battery 12 from the current sensor 12i, and the temperature αb of the battery 12 from the temperature sensor 12t are inputted to ECU 50. ECU 50 also receives the rotational position θm of the rotor of the motor 20 from the rotational position sensor 20a, the phase current Iu, Iv, Iw of each phase of the motor 20 from the current sensor 20u, 20v, 20w, and the temperature αm of the motor 20 from the temperature sensor 20t. ECU 50 also receives the temperature αi1 of the first inverter 22 from the temperature sensor 22t, the temperature αi2 of the second inverter 24 from the temperature sensor 24t, the voltage VH of the capacitor 30 from the voltage sensor 30v, the temperature αsp of the positive-side switch 33 from the temperature sensor 33t, the temperature αsn of the negative-side switch 34 from the temperature sensor 34t, and the temperature αw of the coolant in the circulation flow path 42 from the temperature sensor 48. ECU 50 also receives an on-off signal from the power switch, a shift position SP which is an operation position of the shift lever from the shift position sensor, an accelerator operation amount Acc which is a depression amount of the accelerator pedal from the accelerator pedal position sensor, a brake pedal position BP which is a depression amount of the brake pedal from the brake pedal position sensor, a vehicle speed V from the vehicle speed sensor, and an outside air temperature αo from the outside air temperature sensor 52.

Various control signals are outputted from ECU 50. For example, ECU 50 outputs a control signal from the transistor T11 of the first inverter 22 to T16, the transistor T21 of the second inverter 24 to T26, the positive-side switch 33, and the negative-side switch 34. ECU 50 calculates the power storage ratio SOC of the battery 12 based on the integrated value of the current Ib of the battery 12, and calculates the electric angle θe and the rotational speed Nm of the motor 20 based on the rotational position θm of the rotor of the motor 20.

In battery electric vehicle 10 of the embodiment, ECU 50 sets a required torque Td* required for traveling based on the accelerator operation amount Acc and the vehicle speed V. ECU 50 sets the torque command Tm* of the motor 20 so as to travel according to the set required torque Td*, and performs switching control of T26 from T16, T21 to the transistors T11 of the first and second inverters 22 and 24 based on the set torque command Tm*.

Next, the operation of battery electric vehicle 10 of the embodiment will be described. In particular, an operation when at least one of the battery 12, the motor 20, the first and second inverters 22 and 24 is requested to increase the temperature while the vehicle is stopped to execute the warm-up control will be described. Such a temperature increase request is made, for example, when the outside air temperature αo from the outside air temperature sensor 52 is equal to or lower than the threshold value αoref, when the temperature αb of the battery 12 from the temperature sensor 12t is equal to or lower than the threshold value Tbref, when the temperature αm of the motor 20 from the temperature sensor 20t is equal to or lower than the threshold value αmref, when the temperature αi1 of the first inverter 22 from the temperature sensor 22t is equal to or lower than the threshold value αi1ref, when the temperature αi2 of the second inverter 24 from the temperature sensor 24t is equal to or lower than the threshold value αi2ref, and when the temperature αw of the coolant in the circulation flow path 42 from the temperature sensor 48 is equal to or lower than the threshold value αwref. In the warm-up control, the positive-side switch 33 and the negative-side switch 34 are turned on. Then, under the control of the first and second inverters 22 and 24, the current is circulated between the first inverter 22, the motor 20, the second inverter 24, the first power line 28 (the positive-side line 28p and the negative-side line 28n), the second inverter 22 and 24 (including the positive-side switch 33 and the negative-side switch 34), and the first inverter 22 in this order or in the reverse order. As a result, the temperature of the motor 20, the first and second inverters 22 and 24 is increased, and the temperature of the battery 12 is increased by using the heat of the motor 20, the first and second inverters 22 and 24 through the coolant of the circulation flow path 42.

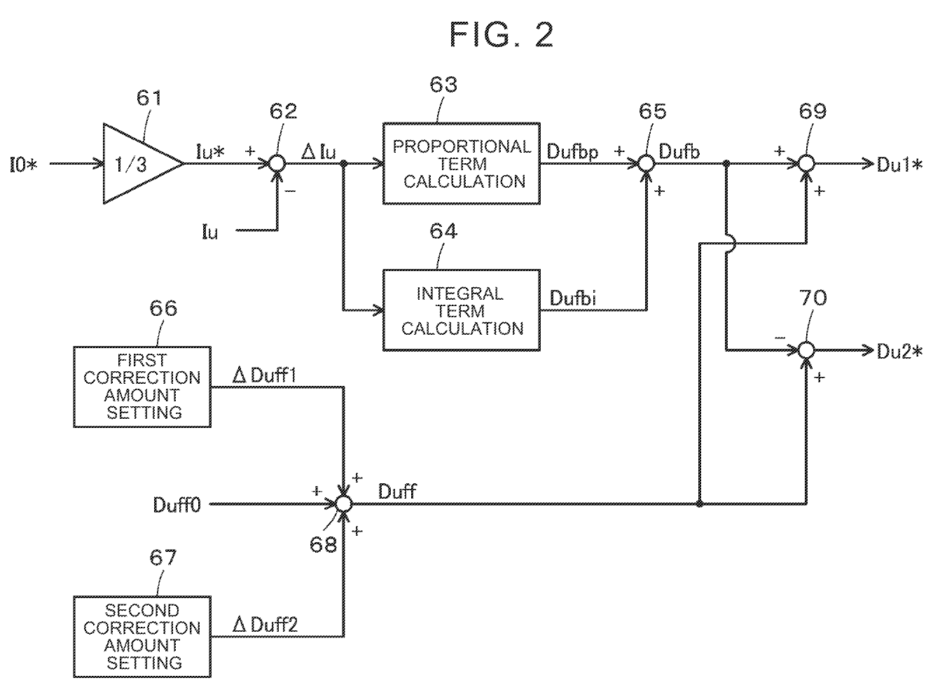

FIG. 2 is an explanatory diagram illustrating an exemplary functional block for controlling the U-phase (transistor T11, T14, T21, T24) of the first and second inverters 22 and 24 in the warm-up control. The functional blocks are constructed by the cooperation of hardware such as a CPU and a plurality of programs installed in a ROM or a flash memory. The same applies to the control of the V-phase (transistor T12, T15, T22, T25) and the W-phase (transistor T13, T16, T23, T26) of the first and second inverters 22 and 24 in the warm-up control.

ECU 50 includes, as functional blocks, a multiplier 61, a subtractor 62, a proportional term calculation unit 63, an integral term calculator 64, an adder 65, a first correction amount setting unit 66, a second correction amount setting unit 67, an adder 68, an adder 69, and a subtracting unit 70. Multiplier 61 calculates the U-phase current command Iu* by multiplying the zero-phase current command I0* by 1/3. The phase current command Iu* and the phase current Iu are positive in the direction from the first inverter 22 to the second inverter 24 (rightward in FIG. 1). The zero-phase current command I0* is a command value of the zero-phase current corresponding to the sum of phase currents of the U-phase, V-phase, and W-phase. The zero-phase current command I0* may be determined based on, for example, the temperature of the battery 12, the motor 20, the first, and second inverters 22 and 24 that are required to be heated, or a predetermined constant value may be used.

Subtracting unit 62 calculates the difference ΔIu by subtracting the phase current Iu from the phase current command Iu* of the U-phase . The proportional term calculation unit 63 and the integral term calculation unit 64 calculate the proportional term Dufbp and the integral term Dufbi by multiplying the difference ΔIu by the gain Kp, Ki of the proportional term and the integral term, respectively. The adder 65 calculates, as the sum of the proportional term Dufbp and the integral term Dufbi, the feedback term Dufb used for setting the first and second duty command Du1*, Du2*. The first and second duty command Du1*, Du2* are the ratio of the on-time of the transistor T11, T21 to the sum of the on-time of the transistors T11, T21 (upper arm) and the on-time of the transistor T14, T24 (lower arm) of the first and second inverters 22 and 24, respectively.

The first and second correction amount setting units 66 and 67 set the first and second correction amounts ΔDuff1 and ΔDuff2. This will be described in detail later. The adder 68 adds the first and second corrections ΔDuff1 and ΔDuff2 to the fundamental Duff0 to calculate the feedforward term Duff used for setting the first and second duty command Du1*, Du2*. As the base Duff0, for example, 0.5 is used. The adder 69 adds the feedback term Dufb to the feedforward term Duff to calculate the first duty command Du1*. The subtracting unit 70 subtracts the feedback term Dufb from the feedforward term Duff to calculate the second duty command Du2*. When the first and second duty command Du1*, Du2* are calculated, the duty control of the transistor T11, T14, T21, T24 is performed based on the calculated first and second duty command Du1*, Du2*.

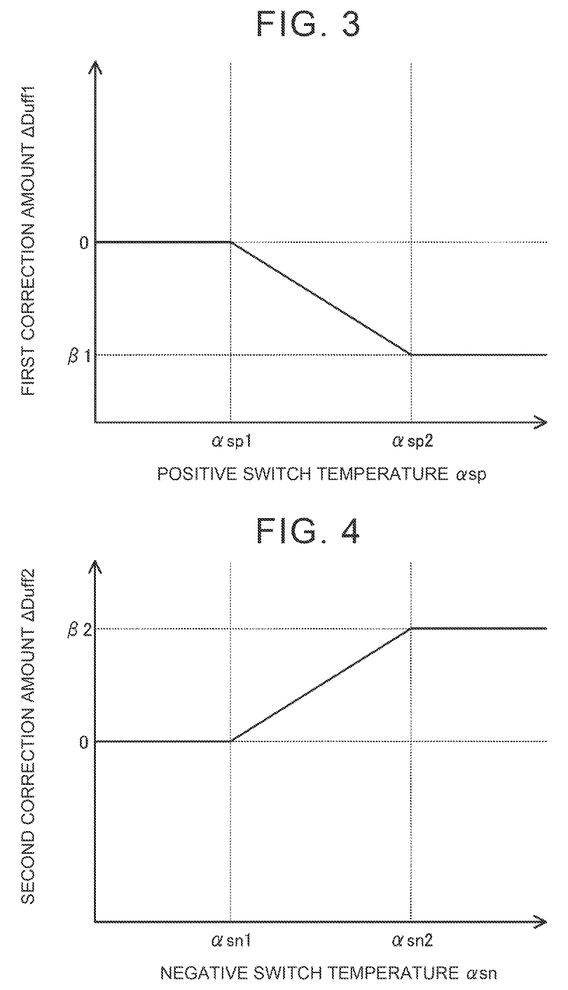

Here, the details of the first and second correction amounts ΔDuff1 and ΔDuff2 setting processing by the first and second correction amount setting units 66 and 67 will be described. The first correction amount setting unit 66 sets the first correction amount ΔDuff1 based on the temperature αsp of the positive-side switch 33 from the temperature sensor 33t and the first correction amount map. The first correction amount map is determined in advance by an experiment, an analysis, or the like based on the specification of the positive-side switch 33 as a relationship between the temperature αsp of the positive-side switch 33 and the first correction amount ΔDuff1. FIG. 3 is an explanatory diagram illustrating an example of the first correction amount map. As illustrated, in a region where the temperature αsp of the positive-side switch is equal to or lower than the threshold value αsp1, the value 0 is set to the first correction amount ΔDuff1. In a region where the temperature αsp of the positive-side switch 33 is higher than the threshold value αsp1 and lower than the threshold value αsp2, a value gradually decreasing from the value 0 toward the negative value β1 is set to the first correction amount ΔDuff1. Further, in a region where the temperature αsp of the positive-side switch 33 is equal to or higher than the threshold value αsp2, the value β1 is set to the first correction amount ΔDuff1. Therefore, the feedforward term Duff and thus the first and second duty command Du1*, Du2* tend to decrease as the temperature αsp of the positive-side switch 33 increases in an area exceeding the threshold αsp1.

The second correction amount setting unit 67 sets the second correction amount ΔDuff2 based on the temperature αsn of the negative-side switch 34 from the temperature sensor 34t and the second correction amount map. The second correction amount map is determined in advance by an experiment, an analysis, or the like based on the specification of the negative-side switch 34 as a relationship between the temperature αsn of the negative-side switch 34 and the second correction amount ΔDuff2. FIG. 4 is an explanatory diagram illustrating an example of a second correction amount map. As illustrated, in a region where the temperature αsn of the negative-side switch is equal to or lower than the threshold value αsn1, the value 0 is set to the second correction amount ΔDuff2. In a region where the temperature αsp of the negative-side switch 34 is higher than the threshold value αsn1 and lower than the threshold value αsn2, a value that gradually increases from the value 0 toward the positive value β2 is set to the second correction amount ΔDuff2. Further, in a region where the temperature αsn of the negative-side switch 34 is equal to or higher than the threshold value αsn2, the value β2 is set to the second correction amount ΔDuff2. Therefore, the feedforward term Duff and thus the first and second duty command Du1*, Du2* tend to increase as the temperature αsn of the negative-side switch 34 increases in an area exceeding the threshold αsn1.

Basically, the smaller the first and second duty command Du1*, Du2*, the smaller the absolute value of the current I0p between the first and second inverters 22 and 24 (including the positive-side switch 33) of the positive-side line 28p. The smaller the first and second duty command Du1*, Du2*, the larger the absolute value of the current I0n between the first and second inverters 22 and 24 (including the negative-side switch 34) of the negative-side line 28n. Based on this, the first and second duty command Du1*, Du2* are made smaller as the temperature αsp of the positive-side switch 33 is higher in the area exceeding the threshold αsp1. Accordingly, the absolute value of the current I0p between the first and second inverters 22 and 24 of the positive-side line 28p can be reduced, and the temperature αsp of the positive-side switch 33 can be suppressed from excessively increasing. Further, the higher the temperature αsn of the negative-side switch 34 is in the range exceeding the threshold αsn1, the larger the first and second duty command Du1*, Du2*. Accordingly, the absolute value of the current I0n between the first and second inverters 22 and 24 of the negative-side line 28n can be reduced, and the temperature αsn of the negative-side switch 34 can be suppressed from being excessively increased.

In the drive device mounted on battery electric vehicle 10 of the embodiment described above, when the temperature αsp of the positive-side switch 33 is higher than the threshold αsp1 at the time of the warm-up control, the first correcting quantity ΔDuff1 is made smaller than when the temperature αsp of the positive-side switch 33 is equal to or lower than the threshold αsp1. As a result, the feedforward term Duff and thus the first and second duty command Du1*, Du2* are reduced. Accordingly, the absolute value of the current I0p between the first and second inverters 22 and 24 of the positive-side line 28p can be reduced, and the temperature αsp of the positive-side switch 33 can be suppressed from excessively increasing.

When the temperature αsn of the negative-side switch 34 is higher than the threshold value αsn1 during the warm-up control, the second correction amount ΔDuff2 is increased as compared with the case where the temperature αsn of the negative-side switch 34 is equal to or lower than the threshold value αsn1. This increases the feedforward term Duff and thus the first and second duty command Du1*, Du2*. Accordingly, the absolute value of the current I0n between the first and second inverters 22 and 24 of the negative-side line 28n can be reduced, and the temperature αsn of the negative-side switch 34 can be suppressed from being excessively increased.

In the above-described embodiment, the feedforward term Duff is added with the feedback term Dufb to calculate the first duty command Du1*, and the feedforward term Duff is subtracted from the feedforward term Dufb to calculate the second duty command Du2*. However, the feedback term Dufb may be subtracted from the feedforward term Duff to calculate the first duty command Du1*, and the feedforward term Dufb may be added to the feedforward term Duff to calculate the second duty command Du2*.

In the above-described embodiment, battery electric vehicle 10 includes the positive-side switch 33 and the negative-side switch 34, but the present disclosure is not limited thereto. For example, only the positive-side switch 33 may be provided. When only the positive-side switch 33 is provided, the second correcting quantity ΔDuff2 is not required in the setting of the feedforward term Duff at the time of the warm-up control.

In the above-described embodiment, the drive device mounted on battery electric vehicle 10 including the motor 20 and the first and second inverters 22 and 24 is configured, but the present disclosure is not limited thereto. For example, in addition to the hardware configuration similar to that of battery electric vehicle 10, the drive device may be mounted on a hybrid electric vehicle that further includes an engine. In addition to the hardware configuration similar to battery electric vehicle 10, the drive device may be mounted on a fuel cell electric vehicle that further includes a fuel-cell.

The correspondence between the main elements of the embodiments and the main elements of the disclosure described in the column of the means for solving the problem will be described. In the embodiment, the battery 12 corresponds to a "power storage device", and the motor 20 corresponds to a "motor". The first inverter 22 corresponds to the "first inverter", the second inverter 24 corresponds to the "second inverter", the positive-side switch 33 corresponds to the "positive-side switch", and ECU 50 corresponds to the "control device". The negative-side switch 34 corresponds to a "negative-side switch".

The correspondence between the main elements of the embodiment and the main elements of the disclosure described in the section of the means for solving the problem is an example for specifically explaining the embodiment of the disclosure described in the section of the means for solving the problem. Therefore, the elements of the disclosure described in the section of the means for solving the problem are not limited. That is, the interpretation of the disclosure described in the section of the means for solving the problem should be performed based on the description in the section, and the embodiments are only specific examples of the disclosure described in the section of the means for solving the problem.

Hereinafter, while embodiments for carrying out the present disclosure are described by using embodiments, it is needless to say that the present disclosure is not limited to such embodiments, and can be implemented in various forms without departing from the gist of the present disclosure.

The present disclosure is applicable to a manufacturing industry of a drive device and the like.

What is claimed is:

1. A drive device, comprising: a power storage device;
a motor with a three-phase open winding;
a first inverter that is connected to a positive-side line and a negative-side line to which the power storage device is connected, and that is also connected to one end side of the three-phase open winding;
a second inverter that is connected to the positive-side line and the negative-side line, and that is also connected to another end side of the three-phase open winding;
a positive-side switch that is provided between the first and second inverters of the positive-side line; and
a control device that, when executing warm-up control for warming at least one of the motor and the first and second inverters, in a state in which the positive-side switch is on, controls the first and second inverters by setting first and second duty commands such that a phase current of each phase of the motor circulates via one inverter of the first and second inverters, a portion of the positive-side line and a portion of the negative-side line between the first and second inverters, and the other inverter of the first and second inverters, wherein,
when a temperature of the positive-side switch is higher than a first temperature during the warm-up control, the control device reduces the first and second duty commands as compared with a case in which the temperature of the positive-side switch is no higher than the first temperature.

2. The drive device according to claim 1, wherein,
during the warm-up control, the control device
adds a feedback term to a feedforward term and sets one of the first and second duty commands, and also subtracts the feedback term from the feedforward term and sets the other of the first and second duty commands, and
when the temperature of the positive-side switch is higher than the first temperature, sets the feedforward term to be smaller than when the temperature of the positive-side switch is no higher than the first temperature.

3. The drive device according to claim 1, further comprising:
a negative-side switch that is provided between the first and second inverters of the negative-side line, wherein,
when a temperature of the negative-side switch is higher than a second temperature during the warm-up control, the control device sets the first and second duty commands to be greater as compared with a case in which the temperature of the negative-side switch is no higher than the second temperature.

4. The drive device according to claim 3, wherein,
during the warm-up control, the control device
adds a feedback term to a feedforward term and sets one of the first and second duty commands, and also subtracts the feedback term from the feedforward term and sets the other of the first and second duty commands,
when the temperature of the positive-side switch is higher than the first temperature, sets the feedforward term to be smaller than when the temperature of the positive-side switch is no higher than the first temperature, and
when the temperature of the negative-side switch is higher than the second temperature, sets the feedforward term to be greater than when the temperature of the positive-side switch is no higher than the second temperature.

5. The drive device according to claim 4, wherein the control device adds, to a basic value of the feedforward term, a first correction value that becomes smaller the higher the temperature of the positive-side switch is, and a second correction value that becomes greater the higher the temperature of the negative-side switch is, and calculates the feedforward term.
